(19) United States
(12) Patent Application Publication
(10) Pub. No.: US 2024/0309605 A1
(43) Pub. Date: Sep. 19, 2024

(54) Construction Machine

(71) Applicant: JDC CORPORATION, Tokyo (JP)

(72) Inventors: Masakazu Sekiguchi, Minato-ku, Tokyo (JP); Akimitsu Ebihara, Minato-ku, Tokyo (JP); Hidetoshi Morimoto, Minato-ku, Tokyo (JP); Hiroshi Obata, Minato-ku, Tokyo (JP); Tsukasa Baba, Minato-ku, Tokyo (JP)

(21) Appl. No.: 18/574,971

(22) PCT Filed: Feb. 16, 2022
(86) PCT No.: PCT/JP2022/006087

§ 371 Date: Dec. 28, 2023

Related U.S. Application Data
(60) Provisional application No. 63/222,484, filed on Jul. 16, 2021.

(51) Int. Cl. E02F 3/96; B02C 21/02; B02C 23/02; B64U 70/93; B64U 101/30; E02F 7/00; E02F 9/08; E02F 9/18

(52) U.S. Cl. CPC E02F 3/964; B02C 21/026; B02C 23/02; B64U 70/93; E02F 7/00; E02F 9/0883; E02F 9/18; B64U 2101/30

(57) ABSTRACT

A construction machine having a high degree of freedom in layout is described. The construction machine includes a main body device that is movable by a moving device, a conveyance device that conveys an excavated object excavated by a working device to the outside of the main body device via the main body device, and a processing device that performs processing on the excavated object when the conveyance device conveys the excavated object.

### TECHNICAL FIELD

The present invention relates to a construction machine such as a hydraulic excavator that performs excavation and loading work, and particularly relates to a construction machine having a high degree of freedom in layout.

### BACKGROUND

Conventionally, automatic operation has been developed also in construction machines such as a backhoe, and automation of excavation work is disclosed in JP Patent Publication No. 2020-041354 A.

### SUMMARY

However, in JP Patent Publication No. 2020-041354 A, a layout of the construction machine is limited because the construction machine has a driver's seat.

Therefore, an object of the present invention is to provide a construction machine having a high degree of freedom in layout. Another object of the present invention is to provide a multifunctional construction machine.

A construction machine according to an embodiment of the present invention includes a main body device that is movable by a moving device, a conveyance device that conveys an excavated object excavated by a working device to the outside of the main body device via the main body device, and a processing device that performs processing on the excavated object when the conveyance device conveys the excavated object.

According to the teachings herein, it is possible to realize a construction machine having a high degree of freedom in layout because the construction machine includes the processing device that performs processing on the excavated object when the excavated object is conveyed by the conveyance device.

### BRIEF DESCRIPTION OF THE DRAWINGS

FIGS. 1A and 1B are schematic views of a construction machine representing a first embodiment of the invention, in which FIG. 1A is a top view and FIG. 1B is a front view.

FIG. 2 is a sectional view taken along line A-A of the construction machine of FIG. 1B.

FIG. 3 is a block diagram of a main part of the first embodiment.

FIG. 4 is a flowchart executed by a heavy machine control device of the first embodiment.

FIGS. 5A to 5D are schematic views of a construction machine representing a second embodiment of the invention, in which FIG. 5A is a view illustrating a state in which a working device is retracted, FIG. 5B is a view illustrating a state in the middle of folding of a sediment feeder and a discharge belt conveyor, FIG. 5C is a view illustrating a state in which the folding of the sediment feeder and the discharge belt conveyor is finished, and FIG. 5D is a view illustrating a state in which the working device is revolved toward the discharge belt conveyor.

FIG. 6 is a flowchart executed by a heavy machine control device of the second embodiment.

FIG. 7 is a schematic view of a hydraulic excavator representing an example of a construction machine that represents a third embodiment of the invention.

FIG. 8 is a schematic view of a hydraulic excavator representing an example of a construction machine that represents a fourth embodiment of the invention.

### DETAILED DESCRIPTION

Hereinafter, a construction machine of a first embodiment of the present invention will be described in detail with reference to the accompanying drawings. Note that the present invention is not limited by the embodiments described below. In the present embodiments, the description will be continued by using a hydraulic excavator 1 as an example of the construction machine.

### First Embodiment

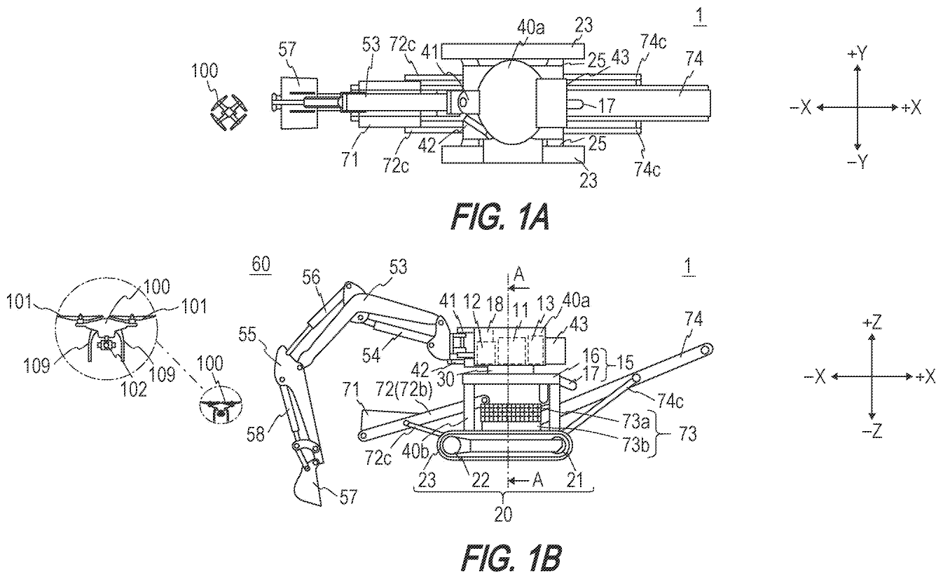

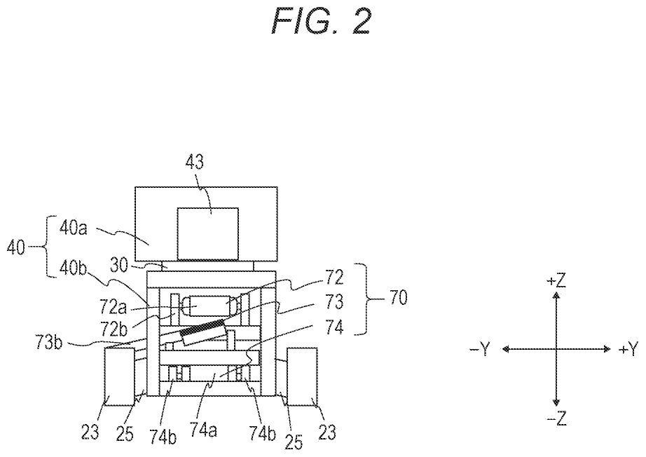

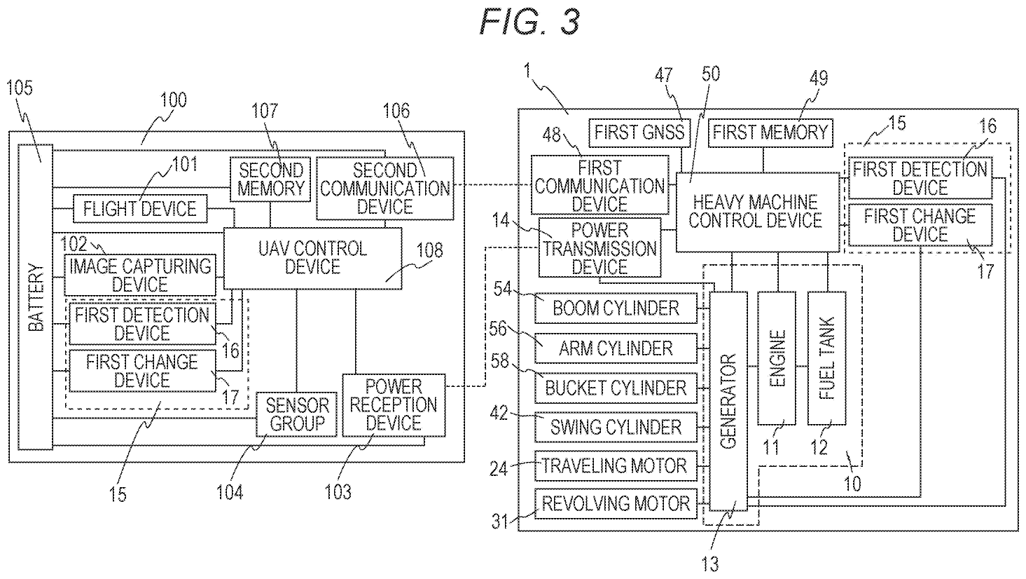

FIGS. 1A, 1B, and 2 are schematic views illustrating a hydraulic excavator 1 representing a first embodiment. FIG. 1A is a top view, FIG. 1B is a front view, and FIG. 2 is a sectional view taken along line A-A of the construction machine of FIG. 1B. Furthermore, FIG. 3 is a block diagram of a main part of the first embodiment. In the following description, for convenience, a vertical direction is defined as a Z direction, and two axial directions orthogonal to each other in a horizontal plane are defined as an X direction and a Y direction. In the sectional view of FIG. 2, illustration of a working device 60 is omitted to prevent the drawing from being complex.

Hereinafter, a configuration of the hydraulic excavator 1 will be described with reference to FIGS. 1A to 3. Furthermore, as is clear from FIGS. 1A and 1B, the hydraulic excavator 1 of the first embodiment is a construction machine of an automatic operation type or a remote operation type without a driver's seat, and includes an unmanned aerial vehicle (UAV), hereinafter referred to as a drone 100. Note that the hydraulic excavator 1 may be traveled by automatic operation at a construction site and may be loaded on a trailer for transportation on a public road. Furthermore, operation of the hydraulic excavator 1 may be automatic operation or a remote operation at a remote place away from an excavation place.

The hydraulic excavator 1 of the first embodiment includes a drive system 10 (see FIG. 3), a first processing device 15, a traveling device 20, a revolving device 30, a main body device 40 having an upper main body device 40a and a lower main body device 40b, a working device 60, and a second processing device 70. Furthermore, the hydraulic excavator 1 includes the drone 100 that can take off and land on a take-off and landing portion provided on an upper surface of the upper main body device 40a. Note that, although one drone 100 is illustrated in FIGS. 1A and 1B, there may be a plurality of the drones 100. In addition, the drone 100 may be a type that flies by electric power, or a type that flies by a fuel cell using hydrogen. By making the number of drones 100 larger than the number of working devices 60 (one in the first embodiment), it is possible to perform monitoring of other devices, charging the drones 100, and the like in addition to monitoring the working devices 60.

The drive system 10 includes an engine 11, a fuel tank 12, and a generator 13, being described later, which are housed in the upper main body device 40a. The engine 11 is an internal combustion engine, and a diesel engine is adopted in the first embodiment. The engine 11 burns fuel supplied from the fuel tank 12 to drive the generator 13.

The fuel tank 12 stores ammonia (NH₃) in a liquid state in the first embodiment, and a residual meter (not illustrated) is provided inside. The ammonia in the liquid state is vaporized by a vaporizer (not illustrated), and the vaporized ammonia is burned together with air by the engine 11. Note that a plurality of the fuel tanks 12 may be provided as an ammonia storage tank and a gas oil storage tank. In this case, it is sufficient that the engine 11 is a mixed combustion type engine that performs mixed combustion of ammonia and gas oil.

The generator 13 is connected to an output shaft of the engine 11, and the generator 13 generates power by a rotational driving force of the output shaft of the engine 11. The power generated by the generator 13 is supplied to various cylinders, various motors, and the like as illustrated in the block diagram of FIG. 3.

A power transmission device 14 supplies power to a power reception device 103 to be described later of the drone 100, and the power transmission device 14 adopts wireless power supply in the first embodiment. The wireless power supply supplies power to the power reception device 103 in a non-contact manner, and a magnetic field resonance system, an electromagnetic induction system, and the like are known. The power transmission device 14 of the first embodiment includes a power supply, a control circuit, and a power transmission coil.

Furthermore, the power transmission device 14 may be a spatial transmission type instead of the proximity junction type described above. In a power supply of the spatial transmission type, power is supplied to an object (in the first embodiment, the power reception device 103 of the drone 100) several meters to several tens of meters away by using an electromagnetic wave such as a microwave.

Note that a contact-type power supply system may be adopted instead of the wireless power supply. In this case, a metal contact may be provided on each of the power transmission device 14 and the power reception device 103, and the contacts may be mechanically connected to each other for power supply. For example, a contact having a recess shape may be provided on the take-off and landing portion, and a contact having a projection shape may be provided on the side of the drone 100. One contact having the recess shape and one contact having the projection shape may be provided, or a plurality of the contacts having the recess shape and a plurality of the contacts having the projection shape may be provided.

The first processing device 15 processes an excavated object excavated by the working device 60.

In the first embodiment, the first processing device 15 includes a first detection device 16 that detects a property of the excavated object excavated by the working device 60, and the first processing device 15 includes a first change device 17 that changes the property of the excavated object. The first detection device 16 detects moisture contained in the excavated object as the property of the excavated object, and the first detection device 16 is provided in the lower main body device 40b to face a discharge belt conveyor 74 described later. As the first detection device 16, a near-infrared moisture meter using near-infrared rays can be employed. The near-infrared moisture meter detects moisture contained in an excavated object by measuring an intensity of near-infrared rays reflected by the measuring object (the excavated object in the first embodiment) using a light receiving element.

In a case where moisture contained in the excavated object is detected by the near-infrared moisture meter, it is necessary to bring the near-infrared moisture meter close to the excavated object by about 10 cm to 50 cm. Therefore, in the first embodiment, the near-infrared moisture meter is provided in the lower main body device 40b, but the present invention is not limited thereto.

In the first embodiment, the first change device 17 changes a rate of water content (percentage of water content) of the excavated object, and the first change device 17 uses a liquid supply device that supplies liquid such as water to the excavated object. The liquid supply device includes a liquid tank 18 that stores water, and a pump, a nozzle, a pipe, and the like that supply the water stored in the liquid tank 18 to the excavated object. Note that in the first embodiment, the first change device 17 is provided in the lower main body device 40b to face the discharge belt conveyor 74 to be described later, and the liquid tank 18 is provided in the upper main body device 40a, but the present invention is not limited thereto.

In the first embodiment, one first detection device 16 and one first change device 17 are provided, but a plurality of first detection devices 16 and a plurality of first change devices 17 may be provided. In this case, the first detection device 16 and the first change device 17 may be provided to face a sediment feeder described later and a sieve 73 described later.

The traveling device 20 includes a pair of crawler belts 23 wound around idler wheels 21 and drive wheels 22, and the traveling device 20 includes a traveling motor (not illustrated) that drives the drive wheels 22. The pair of crawler belts 23 is driven by the drive wheels 22 to cause the hydraulic excavator 1 to travel. A traveling motor 24 is driven by power supplied from the generator 13, and in the first embodiment, an in-wheel motor provided to be coaxially connected to the drive wheels 22 or hubs of the drive wheels 22 is adopted. Note that a hydraulic motor may be used as the traveling motor 24.

The revolving device 30 is disposed between the upper main body device 40a and the lower main body device 40b. The revolving device 30 includes a bearing (not illustrated) and a revolving motor 31 to which power is supplied from the generator 13. The revolving device 30 revolves the upper main body device 40a and the working device 60. Note that the revolving of the main body device 40 and the working device 60 by the revolving device 30 may be performed by a hydraulic motor using hydraulic pressure instead of the revolving motor 31.

The main body device 40 of the first embodiment includes the upper main body device 40a and the lower main body device 40b.

The upper main body device 40a has a cylindrical shape with a flat upper surface and has the power transmission device 14 on the upper surface that supplies power to the drone 100. Furthermore, the power transmission device 14 on the upper surface of the main body device 40 serves as the take-off and landing portion of the drone 100. Note that in the first embodiment, the main body device 40 has a cylindrical shape, but is not limited thereto, and may have any shape.

The upper main body device 40a accommodates the engine 11, the fuel tank 12, the generator 13, and the liquid tank 18. In the upper main body device 40a, the working device 60 is connected to one side via a swing unit 41 and a swing cylinder 42, and a counter mass 43 is connected to the other side. Furthermore, as illustrated in the block diagram of FIG. 3, the upper main body device 40a is provided with a first global navigation satellite system (GNSS) 47 that is a global positioning system, a first communication device 48, a first memory 49, and a heavy machine control device 50 that controls the entire hydraulic excavator 1.

In the first embodiment, the lower main body device 40b is a frame member having a shelf structure, holds the revolving device 30 and the second processing device 70, and is connected to the traveling device 20 via the pair of side frames 25. The lower main body device 40b holds the revolving device 30 in a first stage, which is an upper stage, holds the sediment feeder 72 in a second stage, holds the sieve 73 in a third stage, and holds the discharge belt conveyor 74 in a fourth stage, which is a lower stage.

The swing unit 41 is pivotally supported such that a portion connected to one end side of the upper main body device 40a and a portion connected to a boom 53 are rotatable around a Z axis indicating a vertical direction. The swing cylinder 42 is a cylinder having one end connected to the upper main body device 40a and another end connected to the swing unit 41, and extending and contracting operation of the cylinder is performed by power supplied from the generator 13.

By extension and contraction of the swing cylinder 42, the working device 60 rotates about the Z axis in FIGS. 1A and 1B. Note that the counter mass 43 is a mass body provided on the other end side of the upper main body device 43 that corrects an unbalanced load acting on the main body device 40 caused by an excavation operation of the working device 60.

The first GNSS 47 (see FIG. 3) measures a position of the hydraulic excavator 1 by using an artificial satellite. Note that the first GNSS 47 may be provided at the take-off and landing portion of the upper main body device 40a.

The first communication device 48 includes a transmitter, a receiver, various circuits, an antenna (not illustrated), and the like. The first communication device 48 is a wireless communication unit that accesses a second communication device 106 to be described later or a wide area network such as the Internet. In the first embodiment, the first communication device 48 communicates a flight path of the drone 100 to the second communication device 106 on the basis of a position of the hydraulic excavator 1 detected by the first GNSS 47.

The first memory 49 is a nonvolatile memory (for example, a flash memory). The first memory 49 stores various types of data and programs for driving the hydraulic excavator 1 and various types of data and programs for automatically operating the hydraulic excavator 1. In addition, the first memory 49 stores data regarding a flight path of the drone 100 and a rate of water content (percentage of water content) calculated on the basis of a detection result of the first detection device 16. Furthermore, the first memory 49 may store an amount of liquid supplied by the first change device 17.

The heavy machine control device 50 is a control device that includes a CPU and controls the entire hydraulic excavator 1. The heavy machine control device 50 controls, for example, an excavation operation of the working device 60, a detection operation of the first detection device 16, calculation of a rate of water content (percentage of water content), driving of the first change device 17, and flight operation of the drone 100.

The working device 60 includes the boom 53, a boom cylinder 54, an arm 55, an arm cylinder 56, a bucket 57, and a bucket cylinder 58.

The boom 53 is a rotary L-shaped part connected to the upper main body device 40a via the swing unit 41, and the boom 53 is rotated by the boom cylinder 54.

The arm 55 is connected to a distal end of the boom 53, and the arm 55 is rotated by the arm cylinder 56.

The bucket 57 is connected to a distal end of the arm 55, and the bucket 57 is rotated by the bucket cylinder 58. Note that, instead of the bucket 57, a breaker or the like can be attached to the distal end of the arm 55.

The boom cylinder 54 is a cylinder in which extending and contracting operation is performed by power supplied from the generator 13 to drive the boom 53.

Furthermore, the arm cylinder 56 is a cylinder in which extending and contracting operation is performed by power supplied from the generator 13 to drive the arm 55.

In addition, the bucket cylinder 58 is a cylinder in which extending and contracting operation is performed by power supplied from the generator 13 to drive the bucket 57.

Note that, in the first embodiment, the swing cylinder 42, the boom cylinder 54, the arm cylinder 56, and the bucket cylinder 58 are driven by the power from the generator 13, but these cylinders may be driven using hydraulic pressure.

The second processing device 70 processes an excavated object excavated by the working device 60 and sieves an excavated object in the first embodiment. The second processing device 70 includes a hopper 71, the sediment feeder 72, a sieve 73, and the discharge belt conveyor 74 to sieve an excavated object.

The hopper 71 has a feeding port and a discharge port, receives from the feeding port an excavated object discharged from the bucket 57, and discharges the excavated object from the discharge port to the sediment feeder 72. Because the cross-sectional area of the feeding port is larger than the cross-sectional area of the discharge port, the hopper 71 can temporarily store the excavated object. In the first embodiment, the hopper 71 is supported by a pair of frames 72b of the sediment feeder 72.

The sediment feeder 72 conveys an excavated object from the hopper 71 to the sieve 73. The sediment feeder 72 includes a belt 72a, the pair of frames 72b, and a support portion 72c. The belt 72a is rotationally driven by a motor (not illustrated) to convey an excavated object to the sieve 73. The pair of frames 72b is fixed to a second stage of the lower main body device 40b and rotatably supports the belt 72a. The support portion 72c supports the pair of frames 72b.

The sieve 73 has a mesh 73a for performing sieving and allows an excavated object having a predetermined size or less to pass through an opening of the mesh 73a. As illustrated in FIG. 2, the sieve 73 has a discharge member 73b inclined in the Y direction and discharges in the −Y direction an excavated object such as a rock that has not passed through the opening of the mesh 73a. Note that the mesh 73a is preferably modularized so that a size of the opening can be changed depending on a required property (for example, particle size) of the excavated object. In this case, the mesh 73a may have the same outer dimension, and a plurality of types of opening sizes may be prepared. In addition, to avoid an excavated object from adhering to the mesh 73a, it is preferable to provide a vibration applying member that applies vibration to the mesh 73a. As a vibration applying member, for example, an ultrasonic transducer can be used.

The discharge belt conveyor 74 conveys to a dump truck (not illustrated) an excavated object having passed through the mesh 73a. The discharge belt conveyor 74 includes a belt 74a, a pair of frames 74b, and a support portion 74c. The belt 74a is rotationally driven by a motor (not illustrated) to convey an excavated object to a dump truck (not illustrated). The pair of frames 74b is fixed to a fourth stage of the lower main body device 40b and rotatably supports the belt 74a. The support portion 74c supports the pair of frames 74b.

In the first embodiment, the distance by which the discharge belt conveyor 74 conveys the excavated object is longer than the distance by which the sediment feeder 72 conveys the excavated object. Then, the weight of the discharge belt conveyor 74 is larger than the weight obtained by adding the weight of the hopper 71 to the weight of the sediment feeder 72. Therefore, the discharge belt conveyor 74 can correct an unbalanced load acting on the main body device 40 caused by an excavation operation of the working device 60. As a result, the weight of the counter mass 43 can be reduced.

The drone 100 of the first embodiment includes flight devices 101, an image capturing device 102, the power reception device 103, a sensor group 104, a battery 105, the second communication device 106, a second memory 107, and a UAV control device 108. These components are provided in the main body unit of the drone 100. Note that, as illustrated in FIG. 3, the drone 100 may include at least one of the first detection device 16 and the first change device 17.

The flight device 101 includes a motor (not illustrated) and a plurality of propellers, and the flight device 101 floats the drone 100 in the air and generates thrust to move the drone 100 in the air. Note that, as described above, the number of drones 100 that land on the take-off and landing portion can be optionally set. Furthermore, the configurations of respective drones 100 may be the same, or a part thereof may be changed. Moreover, the sizes of the respective drones 100 may be the same or different.

The image capturing device 102 is a digital camera that includes a lens, an imaging element, an image processing engine, and the like, and captures a moving image and a still image. In the first embodiment, the image capturing device 102 performs surveying and captures an image of an excavated portion.

In an enlarged view surrounded by an alternate long and short dash line in FIG. 1B, the lens of the image capturing device 102 is attached to a side surface (front surface) of the drone 100, but the lens of the image capturing device 102 may be attached to a lower surface of the drone 100, or a plurality of lenses may be provided in the drone 100. Furthermore, a moving mechanism that moves the lens attached to the side surface toward the lower surface may be provided. In addition, a mechanism that rotates the image capturing device 102 around the Z axis may be provided to position the lens of the image capturing device 102 at an optional position around the Z axis. Note that an omnidirectional camera (360-degree Camera) may be used as the image capturing device 102, or a three-dimensional scanner may be used instead of the image capturing device 102.

The power reception device 103 includes power reception coils, charging circuits, and the like provided in leg portions 109 of the drone 100. The power reception device 103 charges the battery 105 with power from the power transmission device 14.

The battery 105 is a secondary battery connected to the power reception device 103. A lithium ion secondary battery, a lithium polymer secondary battery, or the like can be used as the battery 105, but the battery 105 is not limited thereto. The battery 105 can supply power to the flight devices 101, the image capturing device 102, the second communication device 106, the second memory 107, and the UAV control device 108.

The sensor group 104 is a GNSS, an infrared sensor for avoiding collision between the drone 100 and another device (for example, the working device 60), an atmospheric pressure sensor that measures an altitude, a magnetic sensor that detects an azimuth, a gyro sensor that detects a posture of the drone 100, an acceleration sensor that detects acceleration acting on the drone 100, and the like.

The second communication device 106 includes a wireless communication unit and accesses a wide area network such as the Internet and communicates with the first communication device 48. In the first embodiment, the second communication device 106 transmits image data captured by the image capturing device 102 and a detection result detected by the sensor group 104 to the first communication device 48. The second communication device 106 also transmits a flight command from the first communication device 48 to the UAV control device 108.

The second memory 107 is a nonvolatile memory (for example, a flash memory). The second memory 107 stores various types of data and programs for causing the drone 100 to fly and stores image data captured by the image capturing device 102, a detection result detected by the sensor group 104, and the like.

The UAV control device 108 includes a CPU, a posture control circuit, a flight control circuit, and the like, and controls the entire drone 100. Furthermore, the UAV control device 108 determines timing of charging at the take-off and landing portion from a remaining amount of the battery 105, and the UAV control device 108 controls an image capturing position, an angle of view, a frame rate, and the like of the image capturing device 102.

In the hydraulic excavator 1 of the first embodiment configured as described above, the drone 100 can survey an excavation area prior to excavation of the working device 60. The drone 100 can capture an image from the sky and capture an image of the bucket near the bucket 57 during the excavation of the working device 60, so that the excavation can be performed even when an operator is not in the excavation area. Furthermore, when the drone 100 performs image capturing at the take-off and landing portion, image capturing can be performed from substantially the same position as that of a driver's seat of a conventional hydraulic excavator. Because the take-off and landing portion is provided at a top of the upper main body device 40a, the drones 100 can perform image capturing at the take-off and landing portion by the image capturing device 102 without being blocked by the upper main body device 40a.

Note that, as described above, the drone 100 of the first embodiment includes the first detection device 16 and the first change device 17, but drone 100 may include at least one of the first detection device 16 and the first change device 17, or the first detection device 16 and the first change device 17 may be omitted.

In a case where the first change device 17 is provided in the drone 100, the liquid tank 18 in the upper main body device 40a may be used as a tank for supplying liquid to a tank (not illustrated) in the drone 100. In this case, the liquid tank 18 may be provided on the upper surface of the upper main body device 40a. A male joint may be provided on one of the drone 100 and the liquid tank 18, and a female joint may be provided on the other of the drone 100 and the liquid tank 18. When the drone 100 lands on the take-off and landing portion, it is preferable to connect the male joint and the female joint to supply the liquid in the liquid tank 18 to a tank (not illustrated) in the drone 100.

Note that, using a plurality of drones 100 makes it possible that, when a first drone 100 is flying, a second drone 100 is charged at the take-off and landing portion. Thus, it is possible to cause the first drone 100 and the second drone 100 to alternately fly. Note that the number of drones 100 may be three or more.

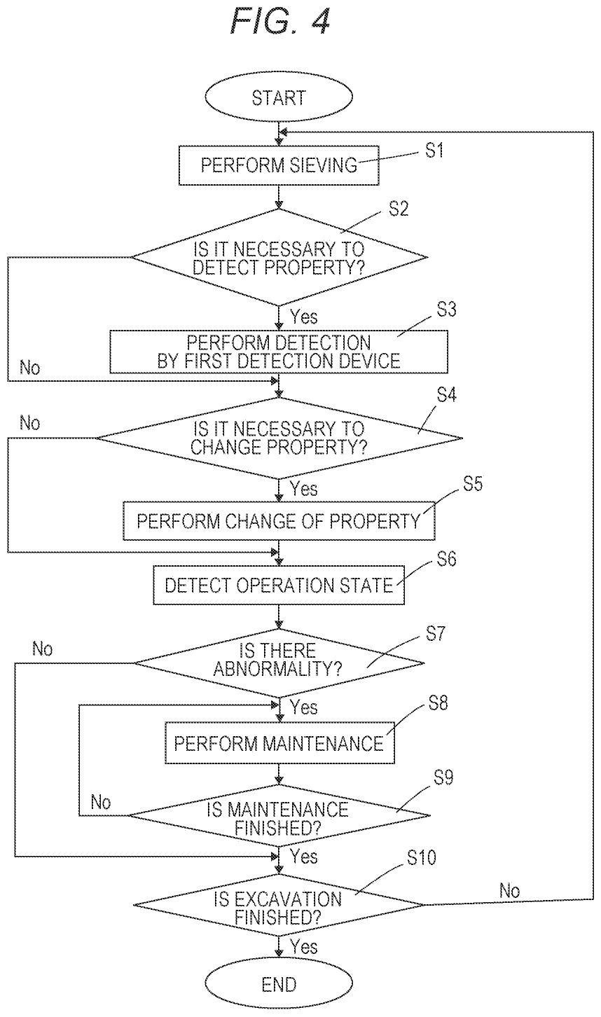

Hereinafter, the description will be continued for the control of the excavation operation and the processing of an excavated object by the heavy machine control device 50 of the first embodiment configured as described above. FIG. 4 is a flowchart executed by the heavy machine control device 50 of the first embodiment.

### Flowchart

When the hydraulic excavator 1 arrives at a place where excavation is performed and preparation for excavation is completed, the heavy machine control device 50 performs excavation with the working device 60 and performs sieving with the second processing device 70 (step S1).

The heavy machine control device 50 feeds an excavated object accommodated in the bucket 57 to the feeding port of the hopper 71. The excavated object discharged from the discharge port of the hopper 71 is discharged to the sediment feeder 72 and conveyed to the sieve 73. In the sieve 73, the excavated object having passed through the mesh 73a is conveyed in the +X direction by the discharge belt conveyor 74. On the other hand, the excavated object that has not passed through the mesh 73a is carried out of the hydraulic excavator 1 by the discharge member 73b.

The heavy machine control device 50 determines whether it is necessary to detect a property of the excavated object that has passed through the mesh 73a (step S2). Here, it is assumed that the property of the excavated object needs to be detected by the first detection device 16, and thus the heavy machine control device 50 proceeds to step S3. When the detection of the property of the excavated object by the first detection device 16 is not necessary, the heavy machine control device 50 proceeds to step S4.

The heavy machine control device 50 detects with the first detection device 16 the property of the excavated object conveyed by the discharge belt conveyor 74 (step S3). The reason why the heavy machine control device 50 detects the property of the excavated object after the sieving is to avoid detecting the property of an excavated object that has not passed through the mesh 73a. In the first embodiment, the heavy machine control device 50 detects moisture contained in an excavated object by the near-infrared moisture meter. The heavy machine control device 50 calculates a rate of water content (percentage of water content) of the excavated object on the basis of the moisture contained in the excavated object detected by the near-infrared moisture meter. The heavy machine control device 50 stores the calculation result in the first memory 49.

The heavy machine control device 50 determines whether it is necessary to detect the property of the excavated object conveyed by the discharge belt conveyor 74 (step S4). Here, it is assumed that the property of the excavated object needs to be changed by the first change device 17, and thus the heavy machine control device 50 proceeds to step S5. When the property of the excavated object does not need to be changed by the first change device 17, the heavy machine control device 50 proceeds to step S6.

In this flowchart, even when detection of the property of the excavated object is not performed in step S2, the heavy machine control device 50 may make the determination in step S4 of “Yes” and change the property of the excavated object. This assumes a case where a property (for example, rate of water content) of the excavated object is known in advance from preliminary excavation or previous experience. As described above, when the hydraulic excavator 1 does not need to detect the property of the excavated object, the first detection device 16 may be omitted.

The heavy machine control device 50 causes the first change device 17 to supply liquid to the excavated object on the basis of the detection result of the first detection device 16, preliminary excavation, or the like so that the excavated object has a predetermined rate of water content (percentage of water content). Note that the rate of water content (percentage of water content) of the excavated object only needs to be adjusted, for example, before banking using the excavated object is completed. Thus, the rate of water content of the excavated object may be adjusted to approach a predetermined rate of water content (percentage of water content) during work by the hydraulic excavator 1. Note that the first change device 17 may be provided with a flow meter, and the heavy machine control device 50 may store the amount of liquid supplied to the excavated object by the first change device 17 in the first memory 49.

The heavy machine control device 50 detects an operation state of the hydraulic excavator 1 (step S6). In the first embodiment, the heavy machine control device 50 detects the operation state of the hydraulic excavator 1 on the basis of an imaging result of the image capturing device 102 of the drone 100. The UAV control device 108 causes the image capturing device 102 to image the working device 60, the second processing device 70, and the periphery of them with causing the drone 100 to fly to avoid collision with the working device 60, the second processing device 70, and the like by the infrared sensor of the sensor group 104. Note that the heavy machine control device 50 may compare rated currents of various motors with load currents to detect the operation states of the various motors.

The heavy machine control device 50 determines whether there is an abnormality in the hydraulic excavator 1 on the basis of the detection of the operation state of the hydraulic excavator 1 performed in step S6 (step S7).

The heavy machine control device 50 determines that there is an abnormality when the image captured by the image capturing device 102 includes an image in which an excavated object falls from the belt 72a or the belt 74a, or an image of a scratch or a slack on the belt 72a or the belt 74a. In addition, when the excavated object discharged by the discharge member 73b includes an image of soil that is usually passed through the opening of the mesh 73a, the heavy machine control device 50 determines that the mesh 73a is clogged and that there is an abnormality.

The heavy machine control device 50 acquires teaching data related to the past abnormality of the hydraulic excavator 1 collected by the drone 100. The heavy machine control device 50 then generates an evaluation model using machine learning to analyze the image captured by the image capturing device 102 in step S6 and determine the presence or absence of an abnormality. Note that the determination in step S7 may be made by a host computer (not illustrated) provided with artificial intelligence through a network, but not by the heavy machine control device 50, or may be made by an operator in a remote place such as a temporary office.

In the first embodiment, the heavy machine control device 50 determines that an abnormality caused by clogging of the mesh 73a has occurred and proceeds to step S8. Note that when determining that no abnormality has occurred, the heavy machine control device 50 proceeds to step S10.

The heavy machine control device 50 performs maintenance of a place where the abnormality has occurred (step S8). In the first embodiment, the heavy machine control device 50 drives a vibration applying member that applies vibration to the mesh 73a to perform maintenance to the clogged mesh 73a. Instead of or in combination with this structure, liquid may be supplied to the mesh 73a by the first change device 17 to clean the mesh 73a. In this case, the first change device 17 is preferably provided in the lower main body device 40b to face the mesh 73a. In addition, the heavy machine control device 50 may supply liquid to the mesh 73a by the first change device 17 provided in the drone 100. Note that compressed gas (for example, air) instead of liquid may be used to eliminate the clogging of the mesh 73a.

The heavy machine control device 50 determines whether the maintenance is finished (step S9). The heavy machine control device 50 generates an evaluation model on the basis of the teaching data in a state where the mesh 73a is not clogged and determines whether the clogging of the mesh 73a has been eliminated. Note that the determination in step S9 may be made by a host computer (not illustrated) through a network, but not by the heavy machine control device 50, or may be made by an operator in a remote place such as a temporary office.

The heavy machine control device 50 repeats step S8 until the maintenance is finished. When the maintenance is finished, the heavy machine control device makes the determination in step S9 of “Yes” and proceeds to step S10. Note that the maintenance in step S8 may be performed by an operator. Examples of the maintenance performed by the operator include replacement of the belt 72a and the belt 74a, adjustment of tension of the belts, and the like.

The heavy machine control device 50 determines whether the excavation using the working device 60 has been finished (step S10). If the excavation has not been finished, the process returns to step S1, and if the excavation has been finished, the flowchart of FIG. 4 ends.

Note that, at the end of the flowchart of FIG. 4, the heavy machine control device 50 may transmit, with the first communication device 48, the data of the rate of water content (percentage of water content) calculated from the moisture contained in the excavated object detected by the first detection device 16 and the data of the supply amount of the liquid supplied by the first change device 17 to, for example, the drone 100, a host computer in a temporary office, a construction heavy machine (bulldozer, motor grader, or the like) that performs banking and leveling using the excavated object, or the like.

In the first embodiment, the mesh 73a is imaged by the image capturing device 102 of the drone 100, but an imaging device may be provided in the lower main body device 40b to face the mesh 73a.

In the first embodiment, because at least a part of the second processing device 70 is provided using the space of the conventional operator cabin, it is possible to provide the hydraulic excavator 1 having a high degree of freedom in layout. Furthermore, because the working device 60 conveys the excavated object to the hopper 71 connected to a lower main body device 70b, the bucket 57 is not driven to the upper portion of the lower main body device 70b, a stroke of the working device 60 in the Z direction can be shortened, and the boom cylinder 54, the arm cylinder 56, and the bucket cylinder 58 can be downsized. Thus, it is possible to realize the hydraulic excavator 1 with reduced energy consumption.

In addition, in the flowchart of FIG. 4, the excavation work, the processing by the first processing device 15, and the processing by the second processing device 70 are performed without driving the revolving device 30 and the revolving motor 31. Therefore, in the first embodiment, the revolving device 30 and the revolving motor 31 can be omitted. In addition, the hydraulic excavator 1 of the first embodiment is also suitable for work in a narrow site, such as a tunnel, where revolving is difficult. Note that it is also possible to adopt a device configuration in which one of the first processing device 15 and the second processing device 70 is omitted.

In the first embodiment, the first detection device 16 and the first change device 17 are provided in the hydraulic excavator 1 and the drone 100. However, one of the first detection device 16 and the first change device 17 may be provided in one of the hydraulic excavator 1 and the drone 100, and the other of the first detection device 16 and the first change device 17 may be provided in the other of the hydraulic excavator 1 and the drone 100. In a case where the first change device 17 is provided in the drone 100, the amount of liquid supplied to the excavated object by the first change device 17 may be stored in the second memory 107.

In the first embodiment, a near-infrared moisture meter is used as the first detection device 16, but instead of using a near-infrared moisture meter, an imaging result by the image capturing device 102 may be used. Teaching data of excavated objects having various rates of water contents (percentages of water contents) may be stored in the first memory 49. The heavy machine control device 50 may estimate moisture contained in the excavated object and a rate of water content (percentage of water content) on the basis of the image captured by the image capturing device 102 and the teaching data. Furthermore, for the estimation of the moisture and the rate of water content (percentage of water content), a host computer provided with artificial intelligence may be used instead of the heavy machine control device 50. Note that the image capturing device 102 may be provided in the hydraulic excavator 1. Furthermore, as the property of the excavated object, particle size of the excavated object may be detected by the image capturing device 102. In addition, the first detection device 16 may be an oil content detection device that detects oil content of an excavated object or an odor detector that detects an odor of the excavated object. Moreover, when the hydraulic excavator 1 is used in a tunnel, the first detection device 16 may be a detection device that detects an oxygen concentration or a concentration of a harmful gas in the tunnel.

Note that a solar power generator may be provided on the upper surface, the side surface, or the like of the upper main body device 40a, and power generated by the solar power generator may be used for driving the hydraulic excavator 1. As the solar power generator, for example, a perovskite solar cell may be used. The perovskite solar cell is a solar cell using a perovskite crystal and is flexible, so that the perovskite solar cell can also be attached to a structure having a curved surface. Furthermore, because the perovskite solar cell is lightweight, an increase in the weight of the hydraulic excavator 1 can be suppressed.

### Second Embodiment

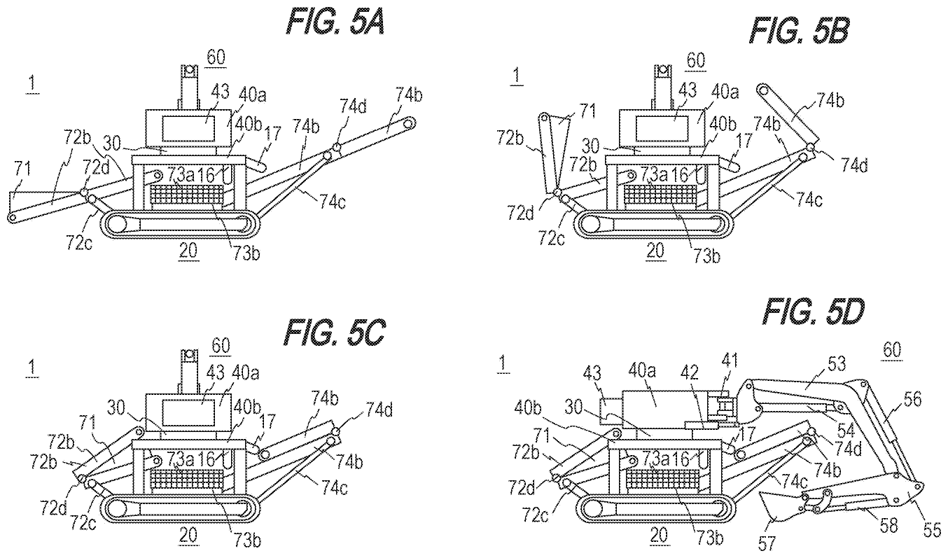

Hereinafter, a second embodiment will be described with reference to FIGS. 5A to 5D, but the same configurations as those of the first embodiment are denoted by the same reference signs, and description thereof will be omitted or simplified. Note that, in these figures, illustration of the drone 100 is omitted, and illustration of the inside of the upper main body device 40a is also omitted. FIGS. 5A to 5D are schematic views of a hydraulic excavator 1 representing an example of the construction machine that represents the second embodiment. FIG. 5A is a view illustrating a state in which the working device 60 is revolved by about 90 degrees by the revolving device 30 and is retracted, FIG. 5B is a view illustrating a state in the middle of folding the sediment feeder 72 and the discharge belt conveyor 74, FIG. 5C is a view illustrating a state in which the folding of the sediment feeder 72 and the discharge belt conveyor 74 is finished, and FIG. 5D is a view illustrating a state in which the working device 60 is revolved toward the discharge belt conveyor 74.

The hydraulic excavator 1 of the second embodiment is provided with a mechanism of folding the sediment feeder 72 and the discharge belt conveyor 74 to have a length enabling the hydraulic excavator 1 to be placed on a loading platform of a truck or on a trailer. Furthermore, the hydraulic excavator 1 of the second embodiment adjusts the height of the working device 60 to have a height enabling the hydraulic excavator 1 to be placed on a loading platform of a truck or on a trailer.

For this reason, the sediment feeder 72 includes a hinge portion 72d foldable toward the lower main body device 40b and a motor (not illustrated) that drives the hinge portion 72d toward the lower main body device 40b. In addition, the discharge belt conveyor 74 includes a hinge portion 74d foldable toward the lower main body device 40b and a motor (not illustrated) that drives the hinge portion 74d toward the lower main body device 40b.

The hinge portion 72d rotatably supports the pair of frames 72b divided along the conveyance direction. Similarly, the hinge portion 74d rotatably supports the pair of frames 74b divided along the conveyance direction.

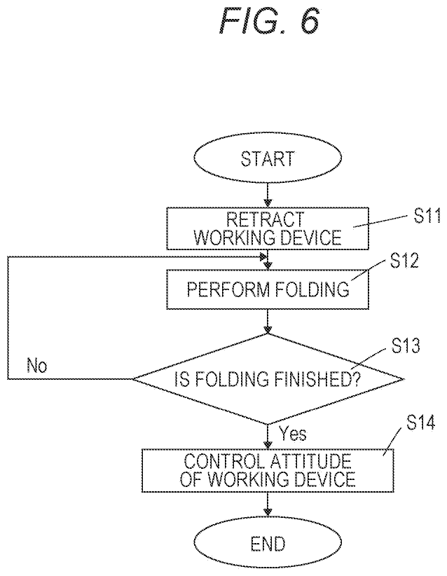

The posture control of the hydraulic excavator 1 by the heavy machine control device 50 of the second embodiment configured as described above will be described below. FIG. 6 is a flowchart executed by the heavy machine control device 50 of the second embodiment.

### Flowchart

The heavy machine control device 50 performs the retracting of the working device 60 before the sediment feeder 72 and the discharge belt conveyor 74 are folded (step S11). The heavy machine control device 50 causes the revolving device 30 to revolve the working device 60 by about 90 degrees so that the working device 60 does not interfere with the sediment feeder 72 and the discharge belt conveyor 74. FIG. 5A illustrates a state of the hydraulic excavator 1 after step S11 is performed.

The heavy machine control device 50 performs the folding of the sediment feeder 72 and the discharge belt conveyor 74 (step S12). FIG. 5B illustrates a state in the middle of folding of the sediment feeder 72 and the discharge belt conveyor 74.

The heavy machine control device 50 determines whether the folding of the sediment feeder 72 and the discharge belt conveyor 74 have been finished (step S13). The completion of the folding of the sediment feeder 72 may be detected on the basis of, for example, an output of a contact sensor provided in the hopper 71. The completion of the folding of the discharge belt conveyor 74 may be detected by, for example, a contact sensor provided to detect a contact between the frames 74b.

The heavy machine control device 50 repeats steps S12 and S13 until the folding of the sediment feeder 72 and the discharge belt conveyor 74 is finished. When the folding of the sediment feeder 72 and the discharge belt conveyor 74 is finished, the heavy machine control device 50 controls a posture of the working device 60 (step S14). As illustrated in FIG. 5D, the heavy machine control device 50 controls a posture of the working device 60 to surround the folded discharge belt conveyor 74. Note that the heavy machine control device 50 may control a posture of the working device 60 to surround the folded sediment feeder 72.

As described above, according to the second embodiment, because a part of the second processing device 70 can be folded, it is possible to realize the hydraulic excavator 1 that can be easily carried by a loading platform of a truck or by a trailer.

### Third Embodiment

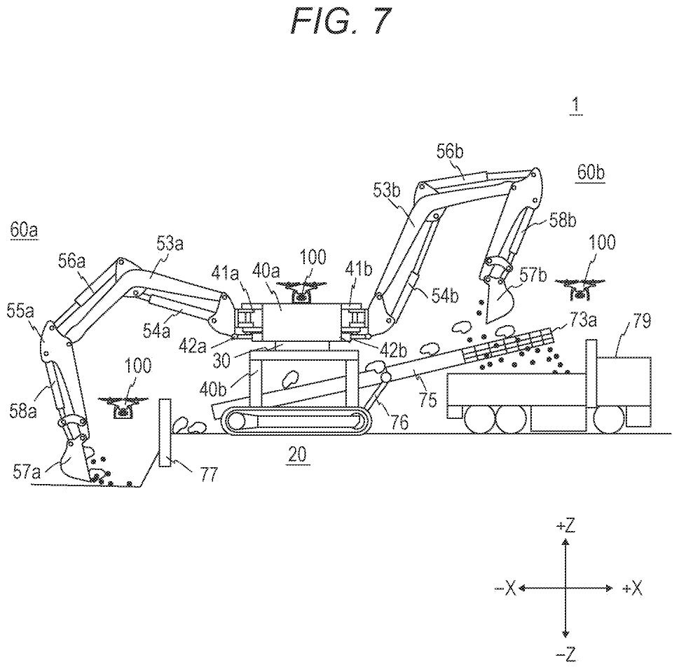

Hereinafter, the third embodiment will be described with reference to FIG. 7, but the same configurations as those of the first and second embodiments are denoted by the same reference signs, and description thereof will be omitted or simplified. FIG. 7 is a schematic view of a hydraulic excavator 1 representing an example of a construction machine that represents the third embodiment.

As illustrated in FIG. 7, the hydraulic excavator 1 of the third embodiment includes two working devices 60. Note that the number of working devices 60 may be three or more.

Here, because configurations of the two working devices 60 are the same as those of the first embodiment and the second embodiment, one is defined as a working device 60a and the other is defined as a working device 60b, and each element constituting the working devices 60a and 60b is also denoted by a reference sign added with a or b in the end.

The second processing device 70 of the third embodiment includes a mesh 73a, a discharge member 75, and a support portion 76. The discharge member 75 is connected to one end of the mesh 73a and discharges an excavated object that has not passed through the opening of the mesh 73a. The discharge member 75 is inclined and thereby discharges the excavated object that has not passed through the opening of the mesh 73a, but the discharge member 75 may be configured to convey the excavated object by a motor (not illustrated) instead of or in combination with this structure. Note that the discharge member 75 may have a structure that can be divided along the longitudinal direction.

The support portion 76 is a member that supports the mesh 73a and the discharge member 75 and has one end connected to the lower main body device 40b. The support portion 76 may support the discharge member 75 at a plurality of places. In the third embodiment, a blocking member 77 is provided so that the discharged excavated object does not return to a place where excavation is performed.

In the hydraulic excavator 1 of the third embodiment, one of the working devices 60 (for example, the working device 60b) is revolved by the revolving device 30 following the excavation, and a bucket 57b is positioned above a loading platform of a dump truck 79. As for the excavated object accommodated in the bucket 57b, an excavated object having a predetermined size or less is discharged to the loading platform of the dump truck 79 through the opening of the mesh 73a of the second processing device 70.

Note that, in the third embodiment, the working device 60a performs excavation while the working device 60b is releasing the excavated object to the loading platform of the dump truck 79. As described above, because the hydraulic excavator 1 of the third embodiment can perform excavation and discharge in parallel, it is possible to realize the hydraulic excavator 1 with good usability. In addition, because the working device 60a is provided on one side of the upper main body device 40a and the working device 60b is provided on the other side of the upper main body device 40a, for example, an unbalanced load acting on the upper main body device 40a caused by the working device 60a performing excavation is corrected by an operation of the working device 60b performing discharge. Therefore, in the third embodiment, the counter mass 43 can be omitted.

In the third embodiment, because an excavated object having a size required in a subsequent process (for example, banking) is selected, it is not necessary to select an excavated object (for example, rock) having a size not required in the subsequent process, which allows the process of the entire construction work to be shortened.

Note that, in a case where it is desired to change a property of an excavated object that has passed through the opening of the mesh 73a, the property can be changed by the first change device 17 of the drone 100 flying in the vicinity of the mesh 73a. In the third embodiment, the first processing device 15 provided in the lower main body device 40b in the first embodiment and the second embodiment can be omitted.

Also in the third embodiment, by making the number of working devices 60 (two in the third embodiment) larger than the third embodiment, it is possible to perform monitoring other devices, charging the drone 100, and the like in addition to monitoring the working devices 60a and 60b. In addition, an image captured by an image capturing device 102 of the drone 100 positioned at the take-off and landing portion of the upper main body device 40a can be used as an image visually recognized by a worker from a conventional driver's seat.

### Fourth Embodiment

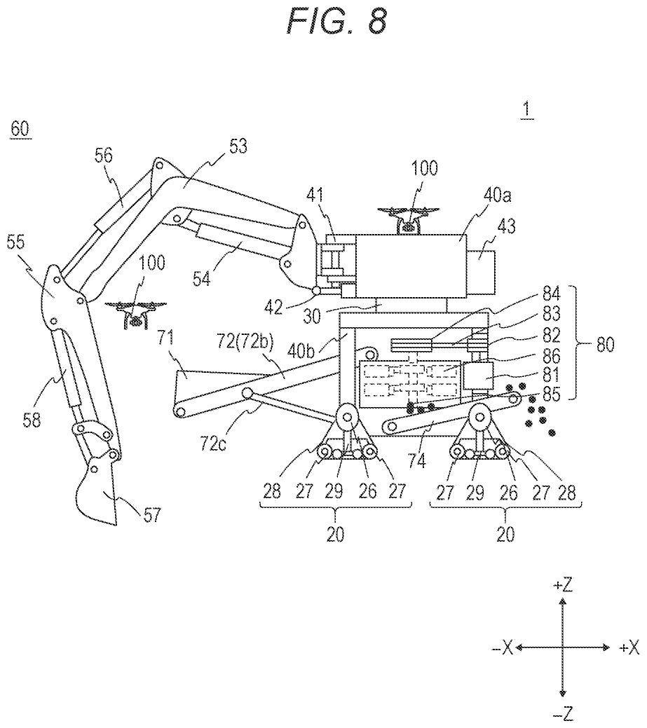

Hereinafter, the fourth embodiment will be described with reference to FIG. 8, but the same configurations as those of the first to third embodiments are denoted by the same reference signs, and description thereof will be omitted or simplified. FIG. 8 is a schematic view of a hydraulic excavator 1 representing an example of a construction machine that represents the fourth embodiment.

In the fourth embodiment, as the second processing device 70, a rotary crushing device 80 is provided in the lower main body device 40b. The rotary crushing device 80 is a device that produces improved soil by crushing construction generated soil (surplus soil) or the like used as a raw material. In addition, the rotary crushing device 80 can mix, as necessary, lime-based binders such as quicklime and slaked lime, cementitious binders such as ordinary cement and blast furnace cement, soil improving materials made of polymer materials, or the like as additives with the construction generated soil to adjust the property, strength, and the like of the improved soil. In the fourth embodiment, improved soil is produced using an excavated object as a raw material excavated by the working device 60. Also in the fourth embodiment, four triangular crawler belt type traveling bodies are used as the traveling device 20.

The rotary crushing device 80 includes a motor 81, a driving pulley 82, a belt 83, a driven pulley 84, a rotating shaft 85, and a crushing unit 86. In the fourth embodiment, the rotary crushing device 80 is controlled by the heavy machine control device 50.

The motor 81 is provided in the lower main body device 40b. The motor 81 is decelerated by the driving pulley 82, the belt 83, and the driven pulley 84 to apply a rotational driving force to the rotating shaft 85.

The driving pulley 82 is connected to the motor 81 and is connected to the driven pulley 84 via the belt 83.

The belt 83 is stretched between the driving pulley 82 and the driven pulley 84 and rotates about the Z axis.

The driven pulley 84 is connected to the rotating shaft 85 and transmits a driving rotational force of the motor 81 to the rotating shaft 85.

The crushing unit 86 is connected to the rotating shaft 85 and has a two-stage configuration separated in the Z direction in the fourth embodiment, but the crushing unit 86 may have a configuration with a single stage or three or more stages. The crushing unit 86 is in a state of hanging down when the motor 81 is stopped. Driving the motor 81 rotates the rotating shaft 85 via the driving pulley 82, the belt 83, and the driven pulley 84. The centrifugal rotation accompanying the rotation of the rotating shaft 85 rotates the crushing unit 86 about the Z axis, thereby crushing excavated objects fed from the sediment feeder 72. Note that a part of the rotating shaft 85 and the crushing unit 86 are housed in a container. Thus, in FIG. 8, a part of the rotating shaft 85 and the crushing unit 86 are indicated by dotted lines.

The excavated object crushed by the crushing unit 86 is conveyed to the outside of the hydraulic excavator 1 (for example, a dump truck (not illustrated)) by the discharge belt conveyor 74 provided below the crushing unit 86.

Note that a more detailed configuration of the rotary crushing device 80 is disclosed in Japanese Patent No. 6466043 filed by the applicant of the present application.

As described above, in the fourth embodiment, four triangular crawler belt type traveling bodies (two crawler belt type traveling bodies are illustrated in FIG. 8) are used as the traveling devices 20. Each of the traveling device 20 is connected to the lower main body device 40b and includes a drive wheel 26, driven wheels 27, a crawler belt 28, and a support 29. In addition, the traveling device 20 includes, as the traveling motor 24, an in-wheel motor that is provided on the back surface side of the drive wheel 26 and transmits a driving force to the drive wheel 26. A rotating shaft of the in-wheel motor is connected to a rotating shaft of the drive wheel 26, the drive wheel 26 is rotated by a rotational driving force of the in-wheel motor, and the driving force is transmitted to the crawler belt 28.

In the fourth embodiment, the one drive wheel 26 and the two driven wheels 27 form a triangular shape. The crawler belt 28 is wound around the one drive wheel 26 and the two driven wheels 27. The support 29 is connected to the lower main body device 40b and rotatably supports the drive wheel 26 and the driven wheels 27.

Because the number of triangular crawler belt type traveling bodies of the fourth embodiment is four, the hydraulic excavator 1 can stably travel even on an uneven ground. In addition, when getting on or off a trailer, the hydraulic excavator 1 is possible to stably travel by the four triangular crawler belt type traveling bodies.

Note that the triangular crawler belt type traveling bodies of the fourth embodiment may be replaced with the traveling device 20 of the first to third embodiments. Conversely, the triangular crawler belt type traveling bodies of the fourth embodiment may be adopted to the traveling device 20 of the first to third embodiments.

In the fourth embodiment, a mass body (counter mass) may also be provided on the +X direction side of the lower main body device 40b to correct an unbalanced load acting on the main body device 40 caused by an excavation operation of the working device 60. By mounting the mass body (counter mass) on the lower main body device 40b, it is possible to suppress an increase in a height of center of gravity of the hydraulic excavator 1.

As described above, according to the fourth embodiment, because the rotary crushing device 80 is provided in a space where a driver's seat is omitted, the hydraulic excavator 1 can perform crushing in addition to excavating the construction generated soil (surplus soil).

Instead of an internal combustion engine, hydrogen and a fuel cell may be used as the drive system 10 of the first to fourth embodiments described above to drive the hydraulic excavator 1. In this case, it is sufficient to store high-pressure hydrogen gas in the fuel tank 12 and supply the hydrogen gas to the fuel cell. If a system that emits less greenhouse gas is used as the drive system 10, it is possible to realize the hydraulic excavator 1 in consideration of the environment.

The embodiments described above are merely examples for describing the present invention, and various changes can be made without departing from the gist of the present invention. For example, in a case of causing the drone 100 to fly in the vicinity of the bucket 57, the UAV control device 108 can avoid collision between the bucket 57 and the drone 100 by recognizing the bucket 57 by the infrared sensor of the sensor group 104.

In addition, the configurations of the hydraulic excavators 1 of the first to fourth embodiments can be appropriately combined.

The following is a list of reference signs used in this specification and in the drawings.
1 Hydraulic excavator
15 First processing device
16 First detection device
17 First change device
18 Liquid tank
30 Revolving device
40 Main body device
50 Heavy machine control device
60 Working device
70 Second processing device
71 Hopper
72 Sediment feeder
73 Sieve
74 Discharge belt conveyor
80 Rotary crushing device
86 Crushing unit
100 Drone
108 UAV control device

1. A construction machine comprising:
a main body device that is movable by a moving device;
a conveyance device that conveys an excavated object excavated by a working device to an outside of the main body device via the main body device; and
a processing device that performs processing on the excavated object when the conveyance device conveys the excavated object.

2. The construction machine according to claim 1, wherein the processing device includes a selection mechanism that selects the excavated object.

3. The construction machine according to claim 1, wherein the processing device includes a change mechanism that changes a property of the excavated object.

4. The construction machine according to claim 3, wherein the change mechanism is provided in an unmanned aerial vehicle capable of flying.

5. The construction machine according to claim 4, wherein a number of the unmanned aerial vehicles is larger than a number of the working devices.

6. The construction machine according to claim 2, wherein the processing device comprises a change mechanism that changes a property of the excavated object selected by the selection mechanism.

7. The construction machine according to claim 1, further comprising a detection device that detects a property of the excavated object.

8. The construction machine according to claim 1, wherein the conveyance device includes a first conveyance mechanism that conveys the excavated object excavated by the working device to the main body device, and a second conveyance mechanism that conveys to the outside of the main body device the excavated object conveyed to the main body device.

9. The construction machine according to claim 1, wherein
the conveyance device includes a folding portion that performs folding, and
the construction machine further includes a control device that positions the working device with respect to the conveyance device when folded.

10. The construction machine according to claim 1, wherein the working device includes a first working device connected to one side of the main body device, and a second working device connected to the other side of the main body device.

11. The construction machine according to claim 1, wherein the processing device includes a crushing device that crushes the excavated object.

12. The construction machine according to claim 1, wherein
the main body device includes an upper main body device and a lower main body device provided below the upper main body device,
the working device is connected to the upper main body device, and
the processing device is connected to the lower main body device.

13. The construction machine according to claim 12, wherein a mass body that corrects an unbalanced load acting on the main body device caused by driving the working device is provided in each of the upper main body device and the lower main body device.

14. The construction machine according to claim 12, further comprising a revolving device located between the upper main body and the lower main body to revolve the upper main body.

15. The construction machine according to claim 12, further comprising a drive system that is housed in the upper main body, the drive system driving at least one of the moving device and the processing device.

16. The construction machine according to claim 15, wherein the drive system includes a fuel tank stores ammonia or hydrogen.

17. The construction machine according to claim 12, further comprising a perovskite solar cell that is provided on the upper main body.

18. The construction machine according to claim 12, wherein the upper main body includes a take-off and landing portion where an unmanned aerial vehicle is able to take off and land portion.

19. The construction machine according to claim 18, wherein the unmanned aerial vehicle includes an image capture device that performs image capture at the take off and land portion.
